(19) United States
(12) Patent Application Publication
(10) Pub. No.: US 2011/0249199 A1
(43) Pub. Date: Oct. 13, 2011

(54) VIDEO PROJECTOR AND LIGHT MODULATION ELEMENT

(75) Inventor: Koji ISHII, Amagasaki-shi (JP)

(73) Assignee: Sanyo Electric Co., Ltd., Osaka (JP)

(21) Appl. No.: 13/077,605

(22) Filed: Mar. 31, 2011

(30) Foreign Application Priority Data
Apr. 9, 2010 (JP) 2010-090748

(51) Int. Cl. H04N 9/31; G02B 26/00

(52) U.S. Cl. 348/744; 359/290; 348/E09.025

(57) ABSTRACT

A video projector includes a light combining member for combining light used to display an image. The light combining member includes a plurality of optical components, each having a corner joined with the corners of the other optical components at a joining center. A projection unit projects the light combined by the light combining member. A light path changing member changes a light path so that light entering the light combining member avoids the joining center.

### CROSS-REFERENCE TO RELATED APPLICATIONS

This application is based upon and claims the benefit of priority from prior Japanese Patent Application No. 2010-090748, filed on Apr. 9, 2010, the entire contents of which are incorporated herein by reference.

### BACKGROUND OF THE INVENTION

The present invention relates to a video projector and a light modulation element for a video projector.

Video projectors that display images on a plane, such as a screen or a wall, are known in the prior art. A video projector generates an image using light emitted from a light source and projects the light of the image. This projects and displays the image on the plane. Such a video projector may include a known light combining member that combines light.

More specifically, a liquid crystal display (LCD) projector is known as a video projector that includes a light combining member. The LCD projector uses three liquid crystal light valves corresponding to the three primary colors of light. Each liquid crystal light valve includes a liquid crystal panel (light modulation element) or the like that modulates light based on an image signal. Light corresponding to the three primary colors of light transmitted through the liquid crystal light valves. This generates separate images of red, green, and blue. The light combining member combines the light of the image for each color to generate a full color image of three or more colors. The liquid crystal projector projects the light of the combined and generated image onto a screen, a wall, or the like to display a full color image.

Referring to FIG. 1, a cross dichroic prism 103 (hereinafter referred to as the prism 103) is generally used as the light combining member. The prism 103 shown in FIG. 1 is a color combining member that combines the light transmitted through liquid crystal light valves 102r, 102g, and 102b. The prism 103 is formed by joining four triangular prisms 131, 132, 133, and 134 (optical components). In such a light combining member that is formed by joining a plurality of optical components, the joining accuracy at the center of the light combining member has a tendency to be low. More specifically, the prism 103 includes a joining center 103a, which joins the four triangular prisms 131, 132, 133, and 134. There is a tendency for a slight gap or step to be formed at the joining center 103a. Thus, the reflection of the light entering the prism 103 may be diffused at the joining center 103a or may not be transmitted through the joining center 103a. The diffused reflection of light at the joining center 103a may result in the joining center 103a forming shadows S as shown in FIG. 2.

To solve the problem of diffused reflection of light at the joining center, Japanese Laid-Open Patent Publication No. 2008-96766 discloses a cross dichroic prism including a light absorption member arranged at the joining center.

However, the light absorbing member of the cross dichroic prism described in the publication absorbs the light transmitted through the joining center. This lowers the use efficiency of the light used to display an image.

### SUMMARY OF THE INVENTION

A first aspect of the present invention is a video projector including a light combining member that combines light used to display an image. The light combining member includes a plurality of optical components, each having a corner joined with the corners Of the other optical components at a joining center. A projection unit projects the light combined by the light combining member. A light path changing member changes a light path so that light entering the light combining member avoids the joining center.

A second aspect of the present invention is a light modulation element for modulating light to generate an image. The light modulation element includes an exit surface from which modulated light exits. The exit surface includes a central portion and a peripheral portion. A light path changing member is arranged on the exit surface. The light path changing member refracts light exiting the central portion of the exit surface toward the peripheral portion of the exit surface.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a path of light transmitted through a light crystal light valve and further transmitted through a light combining member;

FIG. 2 is a schematic diagram showing shadows formed by a joining center in an image with the prior art technology;

FIG. 3 is a schematic diagram showing the structure of a video projector according to one embodiment of the present invention;

FIG. 4A is a perspective view showing a light combining member arranged in the video projector of FIG. 3;

FIG. 4B is a plan view showing the light combining member of FIG. 4A;

FIG. 5A is a perspective view showing a light path changing member arranged in the video projector of FIG. 3;

FIG. 5B is a plan view showing the light path changing member of FIG. 5A;

FIGS. 6A to 6C are cross-sectional views showing the light path changing member showing the relationship between an optical axis of a lens forming the light path changing member and a center axis of an opening in the lens;

FIGS. 7A and 7B are cross-sectional views showing the light path changing member and illustrating a light path changed by the light path changing member;

FIGS. 8A to 8C are schematic diagrams showing a path of light transmitted through a light crystal light valve according to one embodiment of the present invention and further transmitted through the light combining member;

FIG. 9A is a perspective view showing a modification of a light path changing member according to one embodiment of the present invention; and

FIG. 9B is a plan view of the light path changing member of FIG. 9A.

### DETAILED DESCRIPTION OF THE PREFERRED EMBODIMENTS

One embodiment of the present invention will now be described with reference to the drawings.

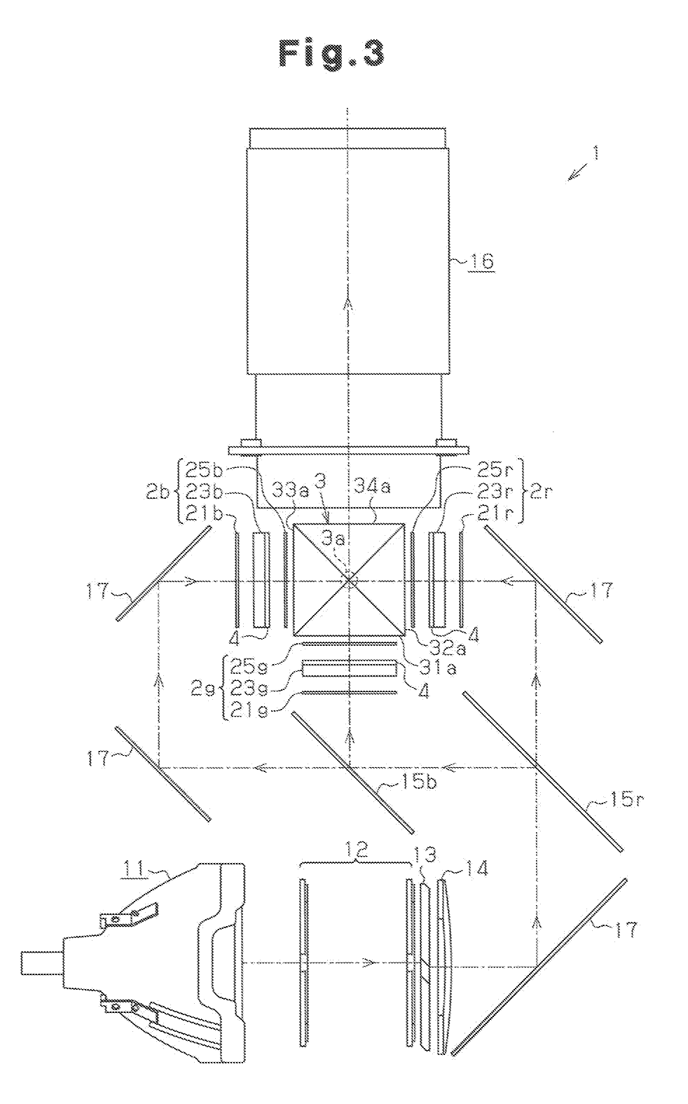

As shown in FIG. 3, a video projector according to the present invention is a LCD projector 1 (hereinafter referred to as the projector 1) of a so-called three-chip type. The projector 1 projects and displays an image onto a plane such as a screen or a wall. The broken line in FIG. 3 indicates an optical axis.

The projector 1 includes optical components for displaying an image, namely, a light source 11, an integrator lens 12, a polarization conversion element 13, a light collecting lens 14, dichroic mirrors 15r and 15b, liquid crystal light valves 2r, 2g, and 2b, a cross dichroic prism 3 (hereinafter referred to as the dichroic prism 3), and a projection lens 16. The projector 1 further includes a reflection mirror 17 that totally reflects the light emitted from the light source 11 to a light path that leads to the above-described optical components.

In addition to the above-described optical components, the projector 1 includes relay lenses, which transmit the light emitted from the light source 11, and an optical compensation plate, which is arranged in each liquid crystal light valve 2r, 2g, and 2b. However, these optical components are not illustrated and will not be described.

The light source 11 is formed by an ultrahigh pressure mercury vapor lamp, a metal halide lamp, or the like. The light emitted from the light source 11 transmitted through passes the integrator lens 12, the polarization conversion element 13, and the light collecting lens 14 strikes the dichroic mirror 15r. The integrator lens 12, which is formed by two fly's eye lenses, uniformly distributes the amount of light emitted from the light source 11, The polarization conversion element 13 adjusts the polarization direction of the light emitted from the light source 11 in one direction. The light collecting lens 14 converges and collects the light emitted from the light source 11.

The dichroic mirror 15r separates the light emitted from the light source 11. More specifically, the light source 11 emits white light. In the white light, the dichroic mirror 15r reflects light having the wavelengths of green and blue and transmits light having the wavelength of red. The light having the wavelength of red (hereinafter referred to as red light) enters the liquid crystal light valve 2r. The light having the wavelengths of green and blue strike the dichroic mirror 15b.

The dichroic mirror 15b separates the light having the wavelength of green and blue. More specifically, the dichroic mirror 15b reflects the light having the wavelength of green (hereinafter referred to as green light) and transmits the light having the wavelength of blue (hereinafter referred to as blue light). The green light enters the liquid crystal light valve 2g, and the blue light enters the liquid crystal light valve 2b.

The liquid crystal light valve 2r includes an entrance side polarization plate 21r, a liquid crystal panel 23r, an exit side polarization plate 25r, and the like. The entrance side polarization plate 21r serves as a light polarizer, which is a modulation element that converts (modulates) circular polarized light and elliptical polarized light into linear polarized light. The red light transmitted through the entrance side polarization plate 21r enters the liquid crystal panel 23r. The red light transmitted through the liquid crystal panel 23r enters the exit side polarization plate 25r, which serves as an analyzer. The red light entering the liquid crystal light valve 2r is transmitted through the entrance side polarization plate 21r to form linear polarized light, which enters the liquid crystal panel 23r.

In the same manner as the liquid crystal light valve 2r, the liquid crystal light valve 2g includes an entrance side polarization plate 21g, a liquid crystal panel 23g, an exit side polarization plate 25g, and the like. The entrance side polarization plate 21g serves as a light polarizer. The green light transmitted through the entrance side polarization plate 21g enters the liquid crystal panel 23g. The green light transmitted through the liquid crystal panel 23g enters the exit side polarization plate 25g, which serves as an analyzer. The green light entering the liquid crystal light valve 2g is transmitted through the entrance side polarization plate 21g to farm linear polarized light, which enters the liquid crystal panel 23g.

Further, in the same manner as the liquid crystal light valves 2r and 2g, the liquid crystal light valve 2b includes an entrance side polarization plate 21b, a liquid crystal panel 23b, an exit side polarization plate 25b, and the like. The entrance side polarization plate 21b serves as a light polarizer. The blue light transmitted through the entrance side polarization plate 21b enters the liquid crystal panel 23b. The blue light transmitted through the liquid crystal panel 23b enters the exit side polarization plate 25b, which serves as an analyzer. The blue light entering the liquid crystal light valve 2b is transmitted through the entrance side polarization plate 21b to form linear polarized light, which enters the liquid crystal panel 23b.

Each of the liquid crystal panels 23r, 23g, and 23b is a light modulation element that modulates light based on an image signal, which is an electrical signal. More specifically, each of the liquid crystal panels 23r, 23g, and 23b is a light modulation element that changes the polarization axis of the linear polarized light. The liquid crystal panels 23r, 23g, and 23b each include a liquid crystal material that is fluid, two glass substrates sandwiching the liquid crystal material, and a plurality of transparent electrodes that apply voltage to the liquid crystal material based on the image signal. The transparent electrodes are arranged in accordance with the number of pixels that form an image.

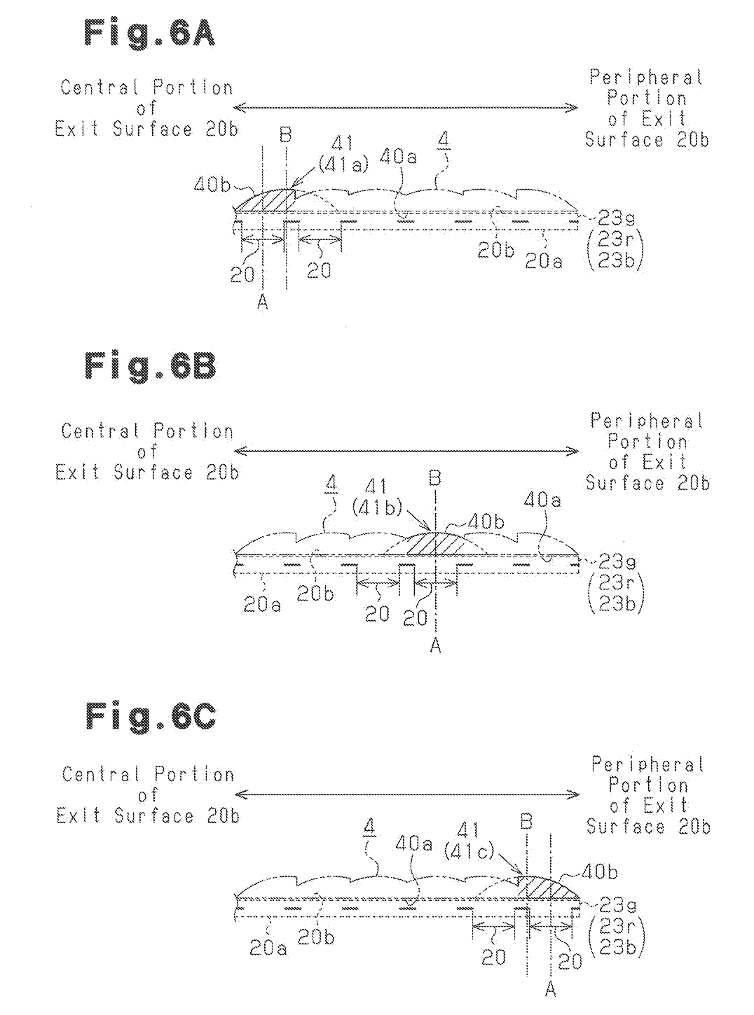

Referring to FIG. 6, the liquid crystal panels 23r, 23g, and 23b each include an entrance surface 20a, from which light for generating an image enters, and an exit surface 20b, from which the modulated light exits. The entrance surface 20a and the exit surface 20b are formed by the two glass substrates described above that sandwich the liquid crystal material.

The liquid crystal panels 23r, 23g, and 23b each include a plurality of openings 20 (see FIG. 6). Each opening 20 corresponds to one of the transparent electrodes, that is, one of the pixels forming an image. The opening 20 is a portion that does not form a wire or transistor connected to the transparent electrode and is a portion through which light passes. The openings 20 are arranged in a matrix and laid out in a vertical direction and horizontal direction, which are orthogonal to each other. That is, in each of the liquid crystal panels 23r, 23g, and 23b, the openings 20 are arranged in the horizontal direction in an m number of rows and in the vertical direction in an n number of columns. Here, “m” and “n” may each be any natural number.

Each of the liquid crystal panel 23r, 23g, and 23b is a light modulation element capable of changing the polarization axis of the linear polarized light entering the entrance surface 20a at each opening 20. In the liquid crystal panels 23r, 23g, and 23b, the polarization axis changes in accordance with the voltage applied to the liquid crystal material. More specifically, each of the liquid crystal panels 23r, 23g, and 23b changes the polarization axis of the linear polarized light by rotating the polarization axis about the optical axis by a greater extend as the voltage applied to the liquid crystal material of the liquid crystal panel decreases. In this manner, each of the liquid crystal panels 23r, 23, and 23b controls the polarization axis of the linear polarised light entering the entrance surface 20a at each opening 20.

The liquid crystal panel 23r controls the polarization axis of the red light entering its entrance surface 20a at each opening 20 so that the red light exits from the exit surface 20b of the liquid crystal panel 23r. This transmits the red light through the liquid crystal panel 23r. The red light transmitted through the liquid crystal panel 23r in this manner enters the exit side polarization plate 25r, which is a light modulation element similar to a light polarizer. When the red light is transmitted through the exit side polarization plate 25r, red image is generated.

The liquid crystal panel 23g controls the polarization axis of the green light entering its entrance surface 20a at each opening 20 so that the green light exits from the exit surface 20b of the liquid crystal panel 23g. This transmits the green light through the liquid crystal panel 23g. The green light transmitted through the liquid crystal panel 23g in this manner enters the exit side polarization plate 25g, which is a light modulation element similar to a light polarizer. When the green light is transmitted through the exit side polarization plate 25g, a green image is generated.

The liquid crystal panel 23b controls the polarization axis of the blue light entering its entrance surface 20a at each opening 20 so that the blue light exits from the exit surface 20b of the liquid crystal panel 23b. This transmits the blue light through the liquid crystal panel 23b. The blue light transmitted through the liquid crystal panel 23b in this manner enters the exit side polarization plate 25g, which is a light modulation element similar to a light polarizer. When the blue light is transmitted through the exit side polarization plate 25b, a blue image is generated.

As described above, each of the liquid crystal panels 23r, 23g, and 23b performs modulation to change the polarization axis of the linear polarized light. This generates the image of each color. Further, each of the liquid crystal light valves 2r, 2g, and 2b emits light of the image of the corresponding color. The light of the image corresponding to each color (i.e., red light, green light, or blue light transmitted through the liquid crystal light valves 2r, 2g, or 2b) then enters the dichroic prism 3.

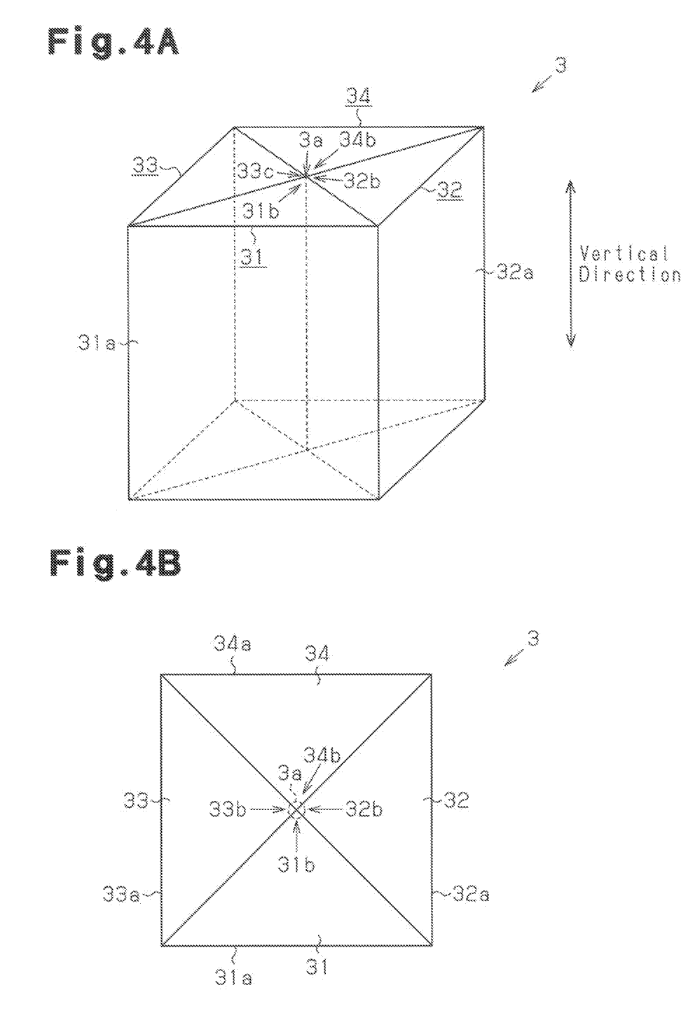

As shown in FIGS. 4A and 4B, the dichroic prism 3, which is cubical, is a color combining prism formed by bonding a plurality of optical components. Further, the dichroic prism 3 is a light combining member that combines the red light, green light, and blue light.

More specifically, the dichroic prism 3 is formed by four triangular prisms 31, 32, 33, and 34, which are optical components. The triangular prisms 31, 32, 33, and 34 each include a bottom having the shape of an isosceles right triangle and walls extending in the vertical direction (linear direction) from the bottom surface. When viewed from above in the vertical direction, the triangular prisms 31, 32, 33, and 34 respectively include corners 31b, 32b, 33b, and 34b that form a right angle.

The triangular prisms 31, 32, and 33 respectively include entrance surfaces 31a, 32a, and 33a, which are planes facing the corresponding vertexes, or the corners 31b, 32b, and 33b. The triangular prism 34 includes an exit surface 34a, which is a plane facing the corresponding vertex, or the corner 34b.

The dichroic prism 3 includes a joining center 3a (i.e., center portion) at which the four corners 31b, 32b, 33b, and 34b of the triangular prisms 31, 32, 33, and 34 are joined in the prism 3. In a plane orthogonal to the vertical direction, central portions in the entrance surfaces 31a, 32a, and 33a of the dichroic prism 3 are respectively arranged to face toward central portions in the exit surfaces 20b of the liquid crystal panel 23g, 23r, and 23b. In other words, the central portions in the liquid crystal panels 23r, 23g, and 23b and the joining center 3a of the dichroic prism 3 are aligned along the same optical axis on a plane orthogonal to the vertical direction.

When the corners 31b, 32b, 33b, and 34b are joined together, the entrance surfaces 31a, 32a, and 33a and the exit surface 34a form wall surfaces of the dichroic prism 3 that extend in the vertical direction. The green light transmitted through the liquid crystal light valve 2g enters the entrance surface 31a, and the red light transmitted through the liquid crystal light valve 2r enters the entrance surface 32a. The blue light transmitted through the liquid crystal light valve 2b enters the entrance surface 33a.

The light of the colors entering the dichroic prism 3 from three directions are guided in the same single direction and combined. More specifically, in the dichroic prism 3 in which the four triangular prisms 31, 32, 33, and 34 are bonded together by transparent adhesive layers (not shown), a dichroic film (not shown) is arranged at the joining portion to reflect red light and blue light, which enter the entrance surfaces 32a and 33a perpendicular to the exit surface 34a, toward the exit surface 34a.

In this manner, the dichroic prism 3 combines the red light, green light, and blue light transmitted through the liquid crystal light valves 2r, 2g, and 2b. This generates a full color image of three or more colors.

The light of the full color image, or the light combined by the dichroic prism 3, exits from the exit surface 34a and enters the projection lens 16, which serves as a projection unit. The projection lens 16 projects the light of the image on a plane such as a screen or a wall and displays an image.

As described above, the projector 1 includes the liquid crystal panels 23r, 23g, and 23b, which serves as light modulation elements that modulate light to generate an image, the dichroic prism 3, which combines image display light modulated by the liquid crystal panels 23r, 23g, and 23b, and the projection lens 16, which project the light combined by the dichroic prism 3.

In the present embodiment, the projector 1 includes lens arrays 4 (refer to FIG. 3), each serving as light path changing member that changes the light path so that the light entering the dichroic prism 3 avoids the joining center 3a.

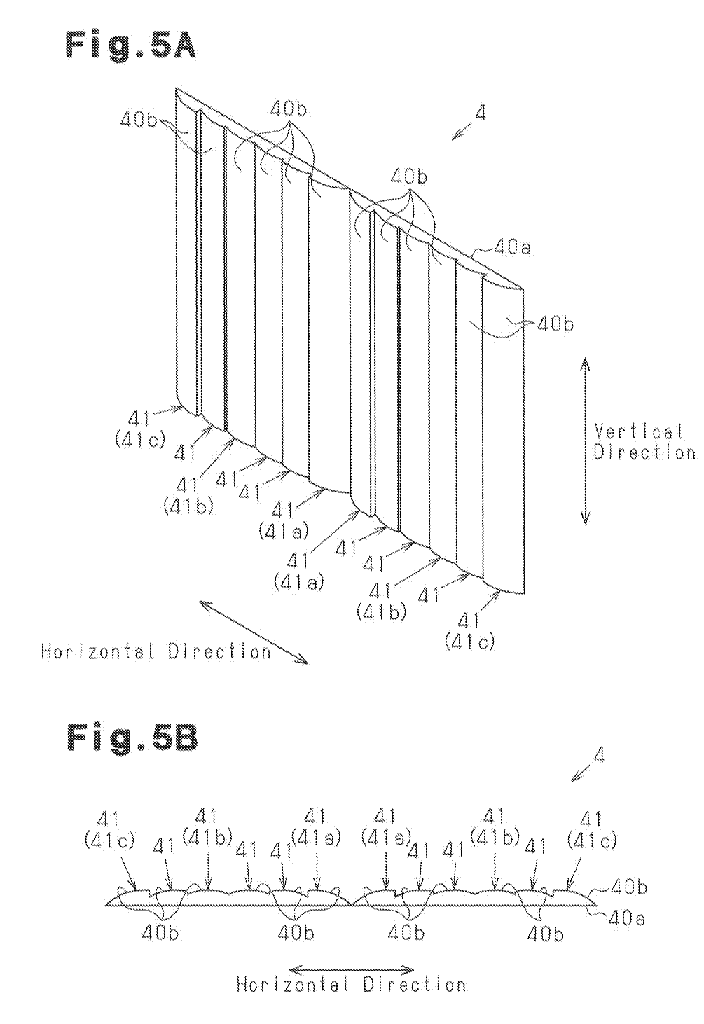

As shown in FIGS. 5A and 5B, each lens array 4 is a micro-lens array formed by a thin plate. The lens array 4 includes a flat surface 40a and curved surfaces 40b. The flat surface 40a forms an entrance surface from which the modulated light enters (specifically, the light transmitted through the corresponding one of the liquid crystal panels 23r, 23g, and 23b). The curved surfaces 40b form an exit surface from which the light that entered the flat surface 40a exits. Each curved surfaces 40b is formed by a convex surface of a lens 41 arranged in the lens array 4. In other words, the lens array 4 includes a plurality of lenses 41 arranged next to one another in the horizontal direction, which is orthogonal to the vertical direction. Each lens 41 includes the curved surface 40b, which is a convex surface bulging outward in the direction light is transmitted. The curved surfaces 40b form the exit surface from which light exits the lens array 4.

The lens array 4 preferably includes a number m of the lenses 41 to change the light path for each opening 20 arranged in the horizontal direction in the corresponding one of the liquid crystal panels 23r, 23g, and 23b. FIGS. 5A and 5B show the lens array 4 with only twelve lenses 41, which are arranged next to one another in the horizontal direction to facilitate illustration.

In the present embodiment, each lens 41 extends in the vertical direction and has a cross-sectional shape that remains the same in the vertical direction. In other words, each lens 41 has the shape of part of a cylinder, and the curved surface 40b of the lens 41 is cylindrical.

As shown in FIG. 6, the lens array 4 is arranged on the exit surface 20b. FIG. 6 shows the lens array 4 arranged on the exit surface 20b of the liquid crystal panel 23g. In the same manner, lens arrays 4 are arranged on the exit surfaces 20b of the liquid crystal panels 23r and 23b. In other words, a lens array 4 is arranged on the exit surface 20b of each of the liquid crystal panel 23r, 23g, and 23b. The lens array 4 is fixed to the liquid crystal panel 23r, 23g, 23b by bonding the flat surface 40a of the lens array 4 with a transparent adhesive layer (not shown).

The lenses 41 are arranged in correspondence with the openings 20 in the lens array 4 of the corresponding liquid crystal panels 23r, 23g, and 23b as described above. In other words, the light passing through one opening 20 is transmitted through one lens 41. However, a single lens 41 may be formed to correspond to two or more openings 20.

Each opening 20 includes a center axis A, and each lens 41 includes an optical axis B. In a cross-section perpendicular to the vertical direction, each lens 41 is positioned on the exit surface 20b so that its optical axis B is in correspondence with the center axis A of the corresponding opening 20. The degree of offset of the center axis A with respect to the optical axis B differs in accordance with the position of the opening 20. The relationship of the center axis A of the opening 20 and the optical axis B of the lens 41, through which the light passing through the opening 20 is transmitted, will now be discussed with reference to FIGS. 6A to 6C. Here, the optical axis B is an axis of symmetry (i.e., center axis) of the lens 41, at which a cross-section orthogonal to the vertical direction is symmetrical.

FIGS. 6A to 6C show the cross-sections of the lens array 4 orthogonal to the vertical direction. FIG. 6A shows the relationship between the optical axis B of one of the lenses 41, namely, a lens 41a, arranged at the central portion of the exit surface 20b and the center axis A of the corresponding opening 20. FIG. 6C shows the relationship between the optical axis B of one of the lenses 41, namely, a lens 41c, arranged at a peripheral portion of the exit surface 20b and the center axis A of the corresponding opening 20. FIG. 6B shows the relationship between the optical axis B of a lens 41b, which is arranged closer to the peripheral portion of the exit surface 20b than the lens 41a and arranged closer to the central portion of the exit surface 20b than the lens 41c, and the center axis A of the corresponding opening 20.

As shown in FIG. 6A, the optical axis B of the lens 41a at the central portion of the exit surface 20b is offset toward the peripheral portion of the exit surface 20b from the center axis A of the corresponding opening 20, through which the light transmitted through the lens 41a passes. The distance between the optical axis B of the lens 41a and the center axis A of the corresponding opening 20 is longer than the distance between the optical axis B of the lens 41b and the center axis A of the corresponding opening 20. In the present embodiment, the distance between the optical axis B of a lens 41 and the center axis A of the corresponding opening 20 decreases from the lens 41a towards the lens 41b. As shown in FIG. 6B, the optical axis B of the lens 41b is aligned with the center axis A of the corresponding opening 20.

As shown in FIG. 6C, the optical axis B of the lens 41c at the peripheral portion of the exit surface 20b is offset toward the central portion of the exit surface 20b from the center axis A of the corresponding, opening 20, through which the light transmitted through the lens 41c passes. In other words, in the present embodiment, the distance between the optical axis B of a lens 41 and the center axis A of the corresponding opening 20 increases from the lens 41b towards the lens 41c. Accordingly, the optical axis B of each lens 41, which transmits the light that passed through the corresponding opening 20, is offset from the center axis A of the opening 20 in directions that differ between the central portion and the peripheral portion of the exit surface 20b.

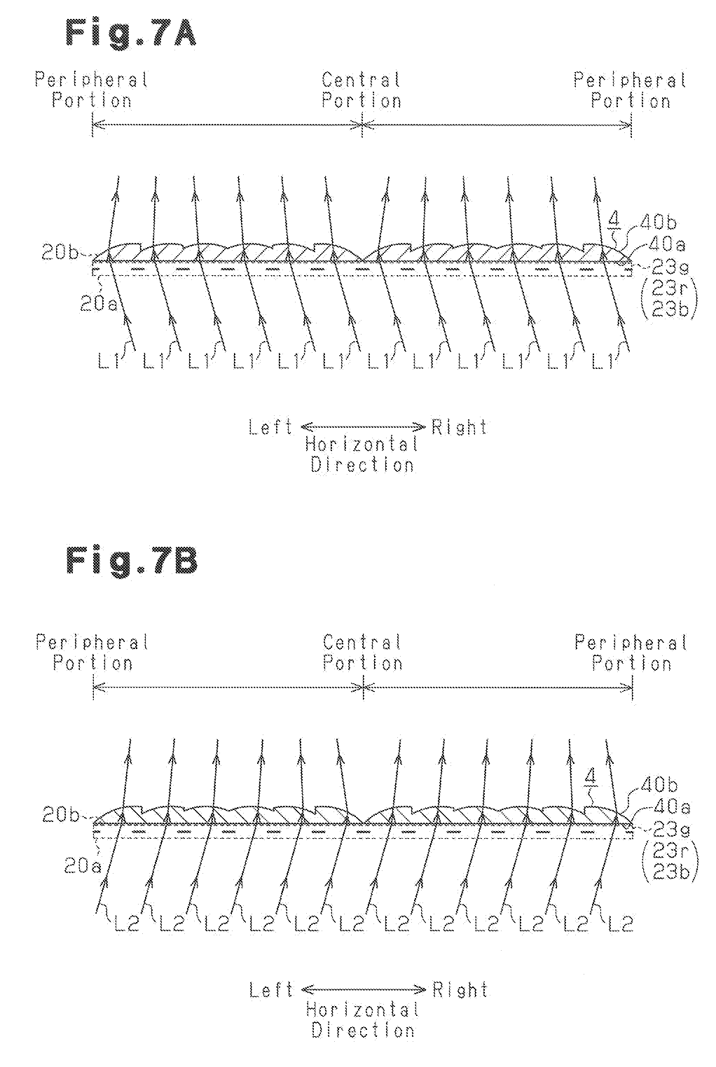

The lens array 4 refracts the light exiting the liquid crystal panels 23r, 23g, and 23b and changes the light path. The light path changed by the lens array 4 will now be described in detail with reference to the schematic diagrams of FIGS. 7A and 7B. FIGS. 7A and 7B, which are cross-sectional views of the lens array 4 taken in a direction orthogonal to the vertical direction, show the light refracted by the lens array 4 of the liquid crystal panel 23g. The lens arrays 4 of the liquid crystal panels 23r and 23b also refract light in the same manner.

Referring to FIGS. 7A and 7B, the light from the light source 11 is converged by the corresponding light collecting lens 14 before entering the liquid crystal light valves 2r, 2g, and 2b. Thus, the light enters the liquid crystal panel 23g at an angle in a predetermined range. FIG. 7A shows the light path of light beams L1 diagonally entering the liquid crystal panel 23g from the right relative to the horizontal direction. FIG. 7B shows the light path of light beams L2 diagonally entering the liquid crystal panel 23g from the left relative to the horizontal direction.

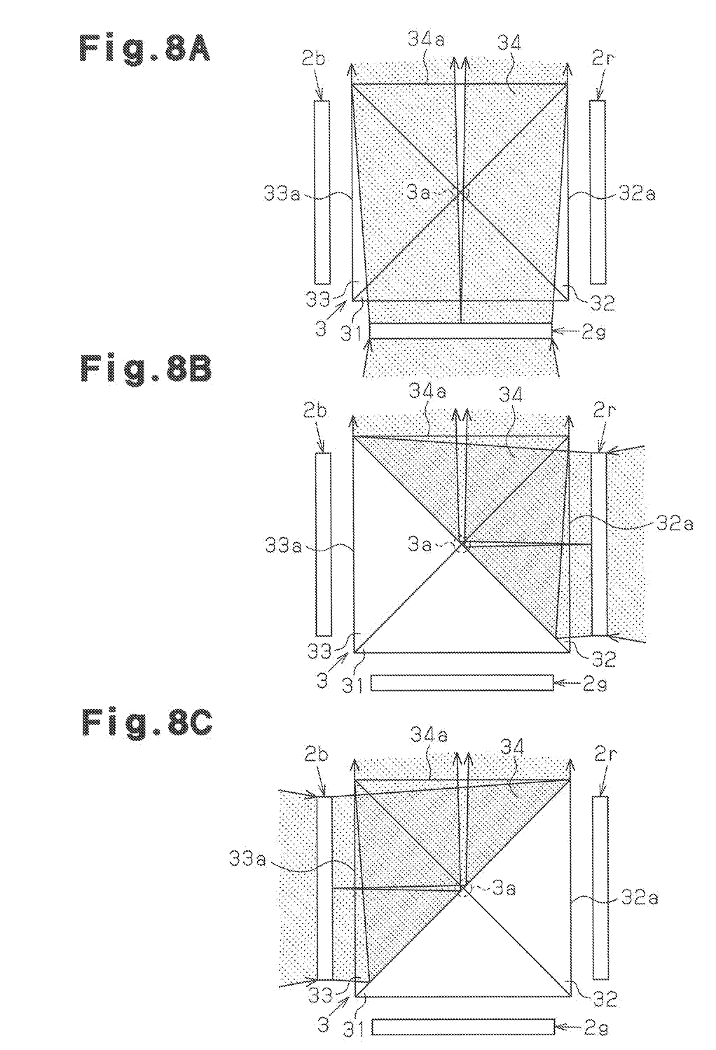

As shown in FIGS. 7A and 7B, the lens array 4 refracts the light beams L1 and L2 exiting from the central portion in the exit surface 20b of the liquid crystal panel 23g toward the peripheral portion of the exit surface 20b. More specifically, the lens array 4 refracts the light exiting the lens 41a at the central portion of the exit surface 20b towards the peripheral portion in the horizontal direction. Thus, as shown in FIG. 8A, the green light, which is transmitted through the liquid crystal light valve 2g, avoids the joining center 3a of the dichroic prism 3 and then exits the exit surface 34a of the dichroic prism 3. Further, as shown in FIG. 8B, the red light, which is transmitted through the liquid crystal light valve 2r, avoids the joining center 3a of the dichroic prism 3 and then exits the exit surface 34a of the dichroic prism 3. Moreover, as shown in FIG. 8C, the blue light, which is transmitted through the liquid crystal light valve 2b, avoids the joining center 3a of the dichroic prism 3 and then exits the exit surface 34a of the dichroic prism 3.

Furthermore, as shown in FIGS. 7A and 7B, the lens array 4 refracts the light beams L1 and L2 exiting from the peripheral portion in the exit surface 20b of the liquid crystal panel 23g towards the central portion of the exit surface 20b. More specifically, the lens array 4 refracts the light exiting the lens 41c at the peripheral portion of the exit surface 20b towards the central portion in the horizontal direction. Thus, as shown in FIG. 8A, the green light, which is transmitted through the liquid crystal light valve 2g and into the dichroic prism 3, is prevented from being reflected by the entrance surfaces 32a and 33a, which are the wall surfaces of the dichroic prism 3. Further, as shown in FIG. 8C, the red light, which is transmitted through the liquid crystal light valve 2r and into the dichroic prism 3, is prevented from being reflected by the entrance surface 32a and exit surface 34a, which are the wall surfaces of the dichroic prism 3. Moreover, as shown in FIG. 8C, the blue light, which is transmitted through the liquid crystal light valve 2b and into the dichroic prism 3, is prevented from being reflected by the entrance surface 33aand exit surface 34a, which are the wall surfaces of the dichroic prism 3.

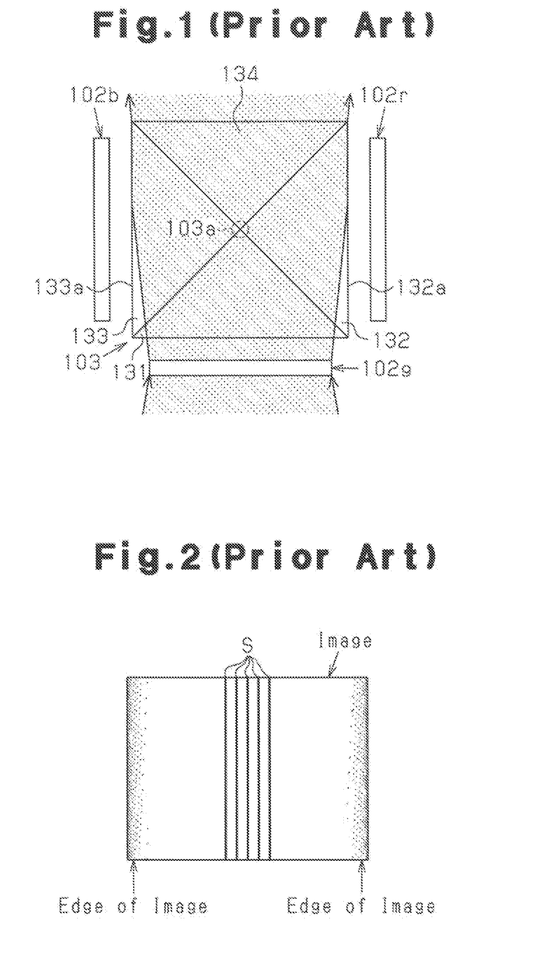

As shown in FIG. 1, in the projector of the prior art, the light transmitted through the peripheral portion of the liquid crystal light valve 102g enters the prism 103 toward the wall surfaces 132a and 133a of the prism 103. When the entering light is reflected by the wall surfaces 132a and 133a of the prism 103, the edge of the image may become dark as shown in FIG. 2 or light leakage may occur. In the present embodiment, the light entering the dichroic prism 3 (light combining member) is prevented from being reflected by the entrance surfaces 32a and 33a and the exit surface 34a, which are the wall surfaces of the dichroic prism 3. Accordingly, the present embodiment prevents the use efficiency of light from being lowered.

The projector 1 of the present embodiment has the advantages described below.

(1) The projector 1 includes the lens arrays 4, each serving as a light path changing member that changes the light path so that the light entering the dichroic prism 3 avoids the joining center 3a. This prevents reflection of the light entering the dichroic prism 3 from being diffused at the joining center 3a. The light that enters the dichroic prism 3 and avoids the joining center 3a is used to display an image. Thus, the use efficiency of the light for displaying an image is high compared to a structure in which the joining center 3a absorbs the light entering the dichroic prism 3. Thus, the projector 1 prevents the use efficiency of light from being lowered in the dichroic prism 3, and shadows of the joining center 3a in the dichroic prism 3 is prevented from being formed in an image.

(2) The light path changing member, which changes the light path so that the light entering the dichroic prism 3 avoids the joining center 3a, is formed by the lens array 4 that includes the lenses 41. Thus, each lens 41 finely changes the light path.

(3) The curved surface 40b of each lens 41 in the lens array 4 is cylindrical. Thus, the cross-sectional shape of the lens array 4 is simplified in comparison to when the curved surface 40b of the lens 41 is spherical.

(4) The liquid crystal panels 23r, 23g, and 23b each include the openings 20, which correspond to the pixels that form an image. The lenses 41 are arranged in correspondence with the openings 20. Thus, each opening 20 changes the light path. Further, the curved surface 40b of each lens 41 in the lens array 4 is cylindrical. Thus, the openings 20 arranged in the same row in the horizontal direction each change the light path. Further, the openings 20 arranged in the same column in the vertical direction use the same lens 41 that extends in the vertical direction.

(5) The liquid crystal panels 23r, 23g, and 23b each include the exit surface 20b from which exits modulated light (i.e., light of which the polarization axis is controlled). Further, each lens array 4 refracts the light exiting from the central portion of the exit surface 20b of the corresponding one of the liquid crystal panels 23r, 23g, and 23b toward the peripheral portion of the exit surface 20b (i.e., away from the optical axis). Thus, even when the central portion of each of the liquid crystal panels 23r, 23g, and 23b and the joining center 3a lie along the same optical axis, the light avoids the joining center 3a by refracting the light towards the peripheral portion of the exit surface 20b.

(6) The lens array 4 refracts the light exiting from the peripheral portion of the exit surface 20b of corresponding one of the liquid crystal panels 23r, 23g, and 23b towards the central portion of the exit surface 20b (i.e., toward the optical axis). This prevents the light entering the dichroic prism 3 from being reflected by the wall surfaces of the dichroic prism 3 (entrance surfaces 32a and 33a and exit surface 34a). Since the wall surfaces of the dichroic prism 3 do not reflect light, the amount of light at the edge of an image is prevented from decreasing.

(7) The projector 1 includes the three liquid crystal panels 23r, 23g, and 23b corresponding to the three primary colors of light and serving as light modulation elements. Further, the liquid crystal panels 23r, 23g, and 23b each include the lens array 4. Accordingly, the light paths of the light transmitted through the liquid crystal panels 23r, 23g, and 23b avoid the joining center 3a of the dichroic prism 3. Thus, in the liquid crystal projector 1 of the so-called three panel type, shadows of the joining center 3a in the dichroic prism 3 are effectively prevented from being formed in an image.

The liquid crystal panels 23r, 23g, and 23b of the present embodiment have the advantages described below.

(8) In each of the liquid crystal panels 23r, 23g, and 23b, serving as a light modulation element that modulates light to generate an image, the corresponding lens array 4 is arranged on the exit surface 20b. The lens array 4 refracts the light exiting from the central portion of the exit surface 20b towards the peripheral portion of the exit surface 20b. The light avoids the joining center 3a by arranging the central portion of each of the liquid crystal panels 23r, 23g, and 23b and the joining center 3a on the same optical axis. As a result, advantage (1) is obtained. Further, advantage (6) is obtained.

It should be apparent to those skilled in the art that the present invention may be embodied in many other specific forms without departing from the spirit or scope of the invention. Particularly, it should be understood that the present invention may be embodied in the following forms.

In the embodiment discussed above, the light path changing member may be formed by a lens array (not shown) including spherical lenses. More specifically, in the same manner as the liquid crystal panels 23r, 23g, and 23b, the light path changing member may be formed by a lens array of spherical lenses arranged in an m number of rows in the horizontal direction and an n number of columns in the vertical direction. Such a structure would also allow lenses to be arranged in correspondence with the openings 20.

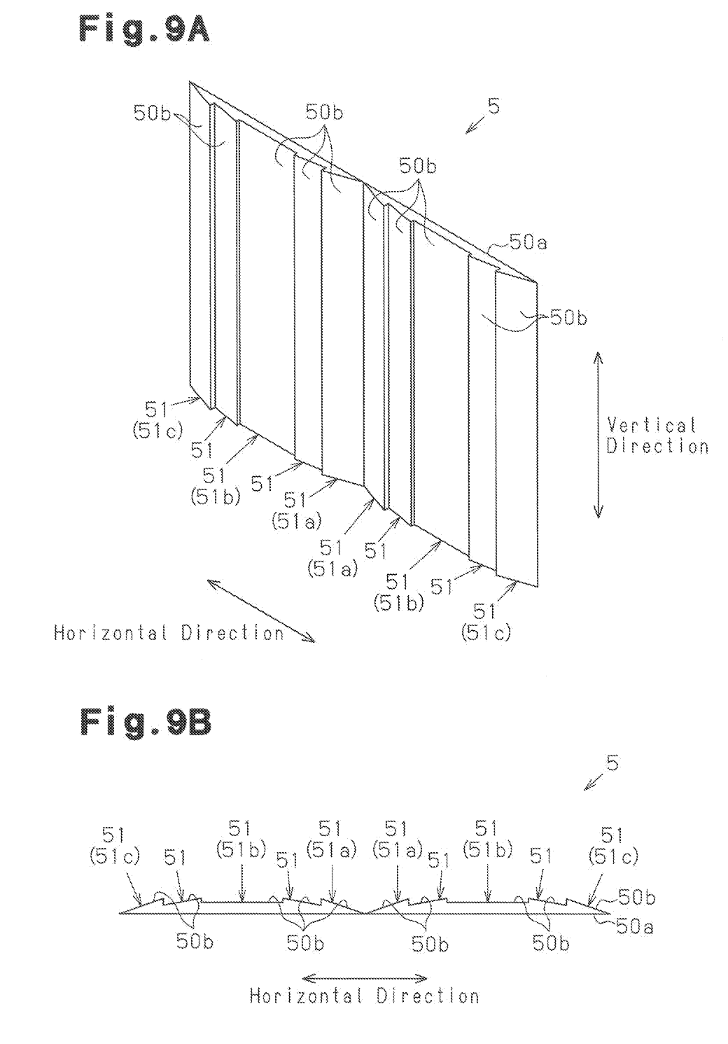

In the embodiment discussed above; the light path changing member may be formed by a prism array 5, which includes a plurality of prism elements 51 as shown in FIGS. 9A and 9B. The prism array 5 shown in FIGS. 9A and 9B will now be described in detail.

As shown in FIGS. 9A and 9B, the prism array 5 is a micro-prism array formed from a thin plate and includes a flat surface 50a, which is an entrance surface into which modulated light enters, and flat surfaces 50b, which are exit surfaces from which exits the light entering the flat surface 50a. Each flat surface 50b is defined by a wall surface of a prism element 51, which forms the prism array 5. In other words, the prism array 5 includes a plurality of prism elements 51 arranged next to one another in the horizontal direction, Each prism element 51 includes the flat surface 50b, which is a wall surface extending at predetermined angle of 0 degrees or greater relative to the horizontal direction. The flat surfaces 50b form exit surfaces of the prism array 5 from which light exits.

The prism array 5 preferably includes an m number of prism elements 51 to change the light path for each opening 20 arranged in the horizontal direction in the liquid crystal panels 23r, 23g, and 23b. FIGS. 9A and 9B show the prism array 5 with only ten prism elements 51 arranged next to one another in the horizontal direction to facilitate illustration. The prism elements 51 shown in FIGS. 9A and 9B extend in the vertical direction, and each prism element 51 has a cross-sectional shape that remains the same in the vertical direction. In other words, the prism element 51 has a prismatic shape.

In the same manner as the lens array 4, the prism array 5 is arranged on the exit surface 20b of each of the liquid crystal panel 23r, 23g, and 23b. Further, in the same manner as the lens array 4, the prism elements 51 are arranged in correspondence with the openings 20 so that the light that passes through each opening 20 is transmitted through one of the prism elements 51 in the prism array 5 arranged on corresponding one of the liquid crystal panels 23r, 23g, and 23b. A single prism element 51 may correspond to two or more openings 20. FIGS. 9A and 9B show prism elements 51b, each corresponding to two openings 20.

In a cross-section perpendicular to the vertical direction, each flat surface 50b of the prism element 51 is inclined relative to the horizontal direction by an extent corresponding to the position in the exit surface 20b of the opening 20 through which the light transmitted through the prism element 51 passes. Accordingly, the flat surfaces 50b are inclined at a degree that differs between prism elements 51a, which are arranged at the central portion of the exit surface 20b, prism elements 51c, which are arranged at the peripheral portion of the exit surface 20b, and the prism elements 51b, which are arranged closer to the peripheral portion of the exit surface 20b than the prism element 51a and closer to the central portion side of the exit surface 20b than the prism element 51c.

More specifically, the flat surface 50b of each prism element 51a arranged at the central portion of the exit surface 20b is inclined relative to the horizontal direction so that the prism element 51 becomes thicker toward the peripheral portion of the exit surface 20b. The degree of inclination of the flat surfaces 50b of the prism elements 51 relative to the horizontal direction decreases from the prism elements 51a toward the prism elements 51b. The flat surfaces 50b of the prism elements 51b are parallel to the horizontal direction.

The flat surface 50b of each prism element 51c arranged at the peripheral portion of the exit surface 20b is inclined relative to the horizontal direction so that the prism element 51 becomes thicker toward the central portion. In the prism array 5 shown in FIGS. 9A and 9B, the flat surface 50b of each prism element 51a is inclined in a different direction from the direction in which the flat surface 50b of each prism element 51c inclines. The degree of inclination of the flat surfaces 50b of the prism elements 51 relative to the horizontal direction increases from the prism element 51b toward the prism elements 51c.

In the same manner as the lens array 4, the prism array 5 refracts light beam L1 and L2 exiting from the central portions of the exit surfaces 20b of the liquid crystal panels 23r, 23g, and 23b toward the peripheral portion of the exit surface 20b. More specifically, the prism array 5 refracts the light exiting from the exit surface 20b toward the peripheral portion in the horizontal direction of the exit surface 20b at the prism elements 51a arranged at the central portion of the exit surface 20b.

Further, in the same manner as the lens array 4, the prism array 5 refracts the light beams L1 and L2 exiting from the peripheral portions in the exit surface 20b of the corresponding one of the liquid crystal panels 23r, 23g, and 23b toward the central portion of the exit surface 20b. Specifically, the prism array 5 refracts the light exiting the prism element 51a arranged at the peripheral portion of the exit surface 20b toward the central portion in the horizontal direction of the exit surface 20b.

As described above, when the light path changing member is the prism array 5 that includes the prism elements 51, advantages (1) to (8) are obtained. More specifically, each prism element 51 can finely change the light path. Further, the light path changing member has a simplified cross-sectional shape compared to a light path changing member formed by a lens array that includes spherical lenses. Further, the light path can be changed for each opening 20 that corresponds to a pixel. Moreover, the openings 20 arranged in the same row in the horizontal direction each change the light path, and openings 20 arranged in the same column in the vertical direction use the same prism element 51 that extends in the vertical direction.

The plurality of prism elements 51 (FIG. 9) may each correspond to one of the openings. In this case, the prism elements 51 may be arranged as a matrix including an m number of rows in the horizontal direction and an n number of columns in the vertical direction.

The light path changing member does not have to be arranged on the liquid crystal panels 23r, 23g, and 23b. The light path changing member may be arranged on other light modulation elements such as the exit side polarization plate 25r, 25g, and 25b respectively forming the liquid crystal light valves 2r, 2g, and 2b. Alternatively, the light path changing member may be arranged separately from the light modulation element.

The light modulation element on which the light path changing member is arranged does not have to be the liquid crystal panel 23r, 23g, and 23b. Further, the light path changing member does not have to be arranged in the liquid crystal light valves 2r, 2g, and 2b. For example, a video projector (not illustrated) that combines red light, green light, and blue light emitted from three light emitting diodes (LEDs) corresponding to the three primary colors of light with a cross dichroic prism to generate white light of the light source may include the light path changing member.

In the embodiment discussed above, the lens array 4 is bonded and fixed to each exit surface 20b of the liquid crystal panels 23r, 23g, and 23b. However, the lens array 4 may be arranged inside each of the liquid crystal panels 23r, 23g, and 23b.

In addition to the light combining member of the cross dichroic prism, the present invention may be applied to any light combining member including a joining center at which the corners of a plurality of optical components are joined.

The present examples and embodiments are to be considered as illustrative and not restrictive, and the invention is not to be limited to the details given herein, but may be modified within the scope and equivalence of the appended claims.

What is claimed is:

1. A video projector comprising:
a light combining member that combines light used to display an image, wherein the light combining member includes a plurality of optical components, each having a corner joined with the corners of the other optical components at a joining center;
a projection unit that projects the light combined by the light combining member; and
a light path changing member that changes a light path so that light entering the light combining member avoids the joining center.

2. The video projector according to claim 1, wherein the light path changing member is a lens array including a plurality of lenses.

3. The video projector according to claim 2, wherein the lenses each include a cylindrical curved surface.

4. The video projector according to claim 2, further comprising a plurality of light modulation elements that modulate light to generate the image, wherein:
the light modulation elements each include a plurality of openings respectively corresponding to a plurality of pixels that form the image;
the light combining member combines the light modulated by each of the light modulation elements as the light used to display an image; and
the plurality of lenses are each arranged in correspondence with at least one of the plurality of openings.

5. The video projector according to claim 4, wherein:
the light modulation elements each include the plurality of openings that are arranged in a vertical direction and a horizontal direction to form a matrix; and
the plurality of lenses are each arranged in correspondence with the ones of the openings arranged in the vertical direction.

6. The video projector according to claim 4, wherein:
the light modulation elements each include an exit surface from which the modulated light exits;
the exit surface includes a central portion and a peripheral portion; and
the light path changing member is formed to refract light exiting the central portion of the exit surface toward the peripheral portion of the exit surface.

7. The video projector according to claim 6, wherein the light path changing member is formed to refract light exiting the peripheral portion of the exit surface towards the central portion of the exit surface.

8. The video projector according to claim 4, wherein:
the plurality of light modulation elements are three liquid crystal panels respectively corresponding to the three primary colors of light;
the light combining member combines light transmitted through each of the liquid crystal panels when the light enters the light combining member; and
the light path changing member is arranged in each of the liquid crystal panels.

9. The video projector according to claim 1, wherein the light path changing member is a prism array including a plurality of prism elements.

10. The video projector according to claim 9, wherein the plurality of prism elements each have a prismatic shape.

11. The video projector according to claim 9, further comprising a plurality of light modulation elements that modulate light to generate the image, wherein:
the light modulation elements each include a plurality of openings respectively corresponding to a plurality of pixels that form the image;
the light combining member combines the light modulated by each of the light modulation elements as the light used to display an image; and
the plurality of prism elements are each arranged in correspondence with at least one of the plurality of openings.

12. The video projector according to claim 11, wherein:
the light modulation elements each include the plurality of openings that are arranged in a vertical direction and a horizontal direction to form a matrix; and
the plurality of prism elements are each arranged in correspondence with the ones of the openings arranged in the vertical direction.

13. The video projector according to claim 11, wherein:
the light modulation elements each include an exit surface from which the modulated light exits;
the exit surface includes a central portion and a peripheral portion; and
the light path changing member is formed to refract light exiting the central portion of the exit surface toward the peripheral portion of the exit surface.

14. The video projector according to claim 13, wherein the light path changing member is formed to refract light exiting the peripheral portion of the exit surface toward the central portion of the exit surface.

15. The video projector according to claim 11, wherein:
the plurality of light modulation elements are three liquid crystal panels respectively corresponding to the three primary colors of light;
the light combining member combines light transmitted through each of the liquid crystal panels when the light enters the light combining member; and
the light path changing member is arranged in each of the liquid crystal panels.

16. A light modulation element for modulating light to generate an image, the light modulation element comprising:
an exit surface from which modulated light exits, wherein the exit surface includes a central portion and a peripheral portion; and
a light path changing member arranged on the exit surface, wherein the light path changing member refracts light exiting the central portion of the exit surface toward the peripheral portion of the exit surface.

17. The light modulation element according to claim 16, wherein the light path changing member is formed to refract light exiting the peripheral portion of the exit surface toward the central portion of the exit surface.
